(19) United States
(12) Patent Application Publication
(10) Pub. No.: US 2024/0321012 A1
(43) Pub. Date: Sep. 26, 2024

(54) Information Processing Apparatus, Method for Processing Information, and Non-Transitory Computer-Readable Storage Medium

(71) Applicant: YAMAHA CORPORATION, Hamamatsu-shi (JP)

(72) Inventor: Yuji MIURA, Hamamatsu-shi (JP)

(21) Appl. No.: 18/735,579

(22) Filed: Jun. 6, 2024

Related U.S. Application Data
(63) Continuation of application No. PCT/JP2021/044827, filed on Dec. 7, 2021.

(51) Int. Cl. G06V 40/20; G06T 5/50; G06T 7/20; G06V 10/44; G06V 40/16

(52) U.S. Cl. CPC G06V 40/28; G06T 5/50; G06T 7/20; G06V 10/44; G06V 40/174; G06T 2207/20221; G10H 2210/091

(57) ABSTRACT

An information processing apparatus includes a first obtainer and an evaluator. The first obtainer obtains an image of a performer playing a drum. Based on the image obtained by the first obtainer, the evaluator evaluates a proficiency of the performer in playing the drum.

### CROSS-REFERENCE TO RELATED APPLICATIONS

The present application is a continuation application of International Application No. PCT/JP2021/044827, filed Dec. 7, 2021. The contents of this application are incorporated herein by reference in their entirety.

### BACKGROUND

The present disclosure relates to an information processing apparatus, a method for processing information, and a non-transitory computer-readable storage medium.

WO/2020/100671 recites an information processing apparatus whose object is to efficiently assist acquisition of skills for musical performance such as piano performance.

There have been demands for techniques to efficiently improve a user's proficiency in playing a musical instrument.

Under the circumstances, an object of the present disclosure is to provide an information processing apparatus, a method for processing information, and a non-transitory computer-readable storage medium such that the apparatus, the method, and the medium efficiently improve a user's proficiency in playing a drum.

### SUMMARY

One aspect is an information processing apparatus that includes a first obtainer and an evaluator. The first obtainer is configured to obtain an image of a performer playing a drum. The evaluator is configured to, based on the image obtained by the first obtainer, evaluate a proficiency of the performer in playing the drum.

Another aspect is a computer system-implemented method for processing information. The method includes obtaining an image of a performer playing a drum. The method also includes evaluating a proficiency of the performer in playing the drum based on the obtained image.

Another aspect is a non-transitory computer-readable storage medium storing a program. When the program is executed by a computer system, the program causes the computer system to obtain an image of a performer playing a drum, and evaluate a proficiency of the performer in playing the drum based on the obtained image.

A more complete appreciation of the present disclosure and many of the attendant advantages thereof will be readily obtained as the same becomes better understood by reference to the following detailed description when considered in connection with the following figures, in which:

### BRIEF DESCRIPTION OF THE DRAWINGS

FIG. 1 is a schematic illustration of a basic configuration example of a drum practice assist system;

FIG. 2 is a flowchart illustrating an example basic operation of an information

processing apparatus;

FIG. 3 is a schematic illustration of an example of calculating a score using a learning model;

FIG. 4 is a schematic illustration of how a learning model learns using training data;

FIG. 5 is a schematic illustration of an example of calculating a score using a learning model that takes, as input information, extraction information extracted from a drum playing image;

FIG. 6 is a schematic illustration of how a learning model learns using training data;

FIG. 7 is a schematic illustration of an example of calculating a score using a learning model that takes, as input information, both a drum playing image and extraction information;

FIG. 8 is a schematic illustration of how a learning model learns using training data;

FIG. 9 is a schematic illustration of proficiency evaluation performed by processing using a rule base;

FIG. 10 is a schematic illustration of proficiency evaluation performed by processing using a rule base;

FIG. 11 is a schematic illustration of proficiency evaluation performed by processing using a rule base;

FIG. 12 is a block diagram illustrating another exemplary functional configuration of the information processing apparatus;

FIG. 13 is a table showing an example of at least one evaluation item related to drum playing;

FIG. 14 is a table showing an example of at least one evaluation item related to drum playing;

FIG. 15 is a table showing an example of at least one evaluation item related to drum playing;

FIG. 16 is a schematic illustration of an example in which an evaluation result and assist information are output;

FIG. 17 is a schematic illustration of an example in which an evaluation result and assist information are output; and

FIG. 18 is a block diagram illustrating an example hardware configuration of a computer that can be used as an information processing apparatus.

### DETAILED DESCRIPTION OF THE EMBODIMENTS

The present specification is applicable to an information processing apparatus, a method for processing information, and a non-transitory computer-readable storage medium.

The embodiments will now be described with reference to the accompanying drawings, wherein like reference numerals designate corresponding or identical elements throughout the various drawings.

Throughout this specification, the expressions “a drum” and “the drum” include individual drums, groups of drums, and drum sets, covering all varieties and assemblies thereof as commonly understood in the field.

### Drum Practice Assist System

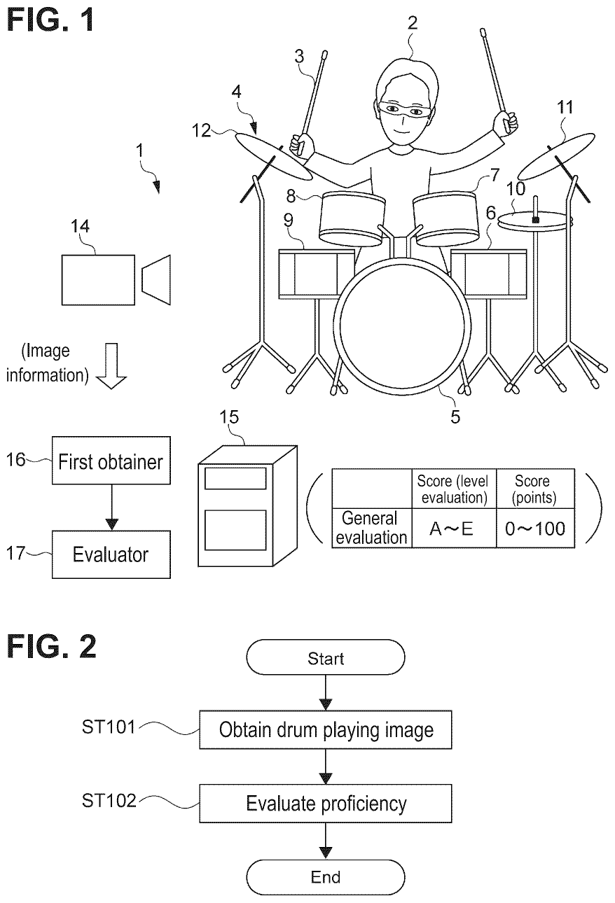

FIG. 1 is a schematic illustration of a basic configuration example of a drum practice assist system 1 according to an embodiment. The drum practice assist system 1 assists a performer (drummer) 2 in playing a drum to efficiently improve the performer's proficiency in playing the drum. As used herein, the term “proficiency” is intended to mean skill level. The drum practice assist system 1 can be referred to as drum proficiency improvement system. The performer 2 can be regarded as a user of this drum practice assist system.

In the present disclosure, the term “drum playing” encompasses any way of playing any form of drum. In the embodiment illustrated in FIG. 1, a drum set 4 is played using a stick 3. The drum set 4 illustrated in FIG. 1 includes a bass drum 5, a snare drum 6, a high tom 7, a low tom 8, a floor tom 9, a hi-hat cymbal 10, a crash cymbal 11, and a ride cymbal 12. This configuration, however, is not intended in a limiting sense; the drum set 4 may have any other configuration. The term “drum playing” will not be limited to playing of the drum set 4; the term encompasses playing of a Japanese drum using a tool such as a stick and playing of various percussions using a hand. It will be readily appreciated that the term “drum playing” also encompasses playing of an electronic musical instrument such as an electronic drum. Some musical instruments are not classified as drums when considered by themselves, even though such musical instruments are often played together with drums. Examples are the various cymbals included in the drum set 4 illustrated in FIG. 1. For another example, a Japanese drum may occasionally be played with a gong. For another example, a percussion may occasionally be played with a wind chime, a cowbell, and/or a shaker. For another example, an electronic cymbal may be installed as part of an electronic drum set. In the present disclosure, the term “drum playing” encompasses playing of this kind of musical instruments played together with drums. That is, playing of the various cymbals described above by referring to FIG. 1 is encompassed within “drum playing”, to which the present disclosure is applicable. Also, some performers show a performance by beating a pot, a pan, a desk, a table, or another object not intended as a musical instrument. The term “drum playing” encompasses the action of beating an object not intended as a musical instrument. Further, there may be a case that drum practice is performed using an object such as a dedicated practice kit (such as a practice pad) and a table. In the present disclosure, drum practice itself is encompassed within “drum playing”.

As illustrated in FIG. 1, the drum practice assist system 1 includes an imaging apparatus (camera) 14 and an information processing apparatus 15. The imaging apparatus 14 and the information processing apparatus 15 are connected to each other in a manner that the apparatuses are communicative to each other wirelessly or via a wire. There is no limitation to the type of connection between the apparatuses. Examples include a wireless local area network (LAN) such as WiFi and near-field wireless communication such as Bluetooth (registered trademark).

The imaging apparatus 14 is provided at a position where the imaging apparatus 14 is able to take an image of the performer 2 playing the drums. An example of the imaging apparatus 14 is a digital camera that includes an image sensor such as a CMOS (Complementary Metal-Oxide Semiconductor) sensor and a CCD (Charge Coupled Device) sensor. Another example of the imaging apparatus 14 is any other imaging device capable of taking an image of drum playing. In the present disclosure, the term “image” is intended to encompass a still image, a sequence of still images, multiple still images spaced throughout time, or images in the form of a video.

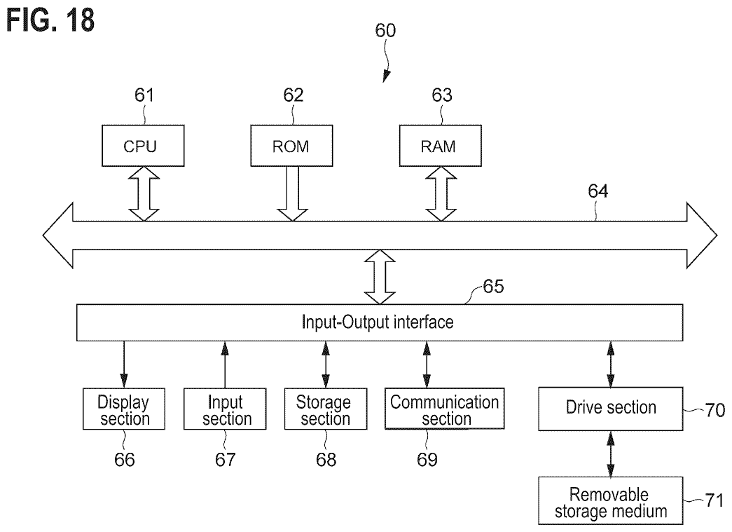

The information processing apparatus 15 includes hardware elements necessary for implementing a computer. Examples include a processor such as a CPU, a GPU, and a DSP, a memory such as a ROM and a RAM, and a storage device such as an HDD (see FIG. 18). For example, the method according to the present disclosure for processing information is performed by causing the CPU to load, to the RAM, a program according to the present disclosure recorded in advance in the ROM and to execute the program. For example, the information processing apparatus 15 may be implemented by any computer such as a PC (Personal Computer). For another example, the information processing apparatus 15 may be implemented by such hardware as a field-programmable gate array (FPGA) and an application specific integrated circuit (ASIC).

In this embodiment, a predetermined program is executed by, for example, the CPU to implement a first obtainer 16 and an evaluator 17, which are functional blocks. It is of course possible to use dedicated hardware such as an IC (integrated circuit) to implement the functional blocks. The program is installed in the information processing apparatus 15 via, for example, various storage media. Another possible example is that the program is installed via the Internet or another network. There is no limitation to the type of the storage medium in which the program is recorded; any computer-readable storage medium may be used. An example is any non-transitory computer-readable storage medium.

FIG. 2 is a flowchart illustrating an example basic operation of the information processing apparatus 15. The first obtainer 16 obtains a drum playing image of the performer 2 playing the drum set 4 (step S101). Based on the drum playing image obtained by the first obtainer 16, the evaluator 17 evaluates an proficiency of the performer 2 in drum playing (this proficiency may occasionally be referred to as drum playing proficiency). For example, a general evaluation on drum playing is performed as schematically illustrated in FIG. 1, and proficiency-indicating scores (evaluation scores) are calculated as an evaluation result of the general evaluation.

In the example illustrated in FIG. 1, the evaluation result is indicated in five levels, A to E, and in numerical points in the range of 0 to 100 points. It is to be noted that the proficiency evaluation will not be limited to a general evaluation on drum playing. The drum playing proficiency may be evaluated based on various evaluation items related to drum playing. That is, the evaluator 17 may evaluate the drum playing proficiency based on at least one evaluation item related to drum playing. This ensures that the drum playing proficiency is evaluated with improved accuracy. It is also to be noted that the evaluation using levels and points as exemplified in FIG. 1 are not intended as limiting the form of scoring; it is possible to use any other form of scoring. It is also to be noted that the proficiency evaluation may be performed by other than scoring. For example, the proficiency evaluation may be performed by displaying an evaluation comment or outputting a particular sound. Another possible example is a proficiency evaluation that does not use parameters as proficiency and evaluation scores and that instead shows a general evaluation or an evaluation based on at least one evaluation item. It is to be noted that an evaluation comment is included in assist information, which is information for improving the drum playing proficiency.

In the example illustrated in FIG. 1, the first obtainer 16 is one embodiment of the first obtainer according to the present disclosure. The evaluator 17 is one embodiment of the evaluator according to the present disclosure.

In the example illustrated in FIG. 1, the imaging apparatus 14 and the information processing apparatus 15 are prepared separately to construct the drum practice assist system 1. This configuration, however, is not intended in a limiting sense. Another possible example is to use any computer that has an imaging function to construct the drum practice assist system 1. That is, an apparatus in which the imaging apparatus 14 and the information processing apparatus 15 illustrated in FIG. 1 are integrally formed may be used as one embodiment of the information processing apparatus according to the present disclosure. Examples of a computer with an imaging function include: a smartphone; a tablet terminal; an HMD (Head Mounted Display) such as an AR (Augmented Reality) glass and a VR (Virtual Reality) glass; and a PC. Proficiency Evaluation (Processing using Machine Learning)

There is no limitation to the method for the evaluator 17 to evaluate the proficiency of the performer 2 in drum playing; it is possible to use any technique (algorithms). For example, it is possible to use any machine learning algorithm using a DNN (Deep Neural Network), an RNN (Recurrent Neural Network), or a CNN (Convolutional Neural Network). For example, it is possible to use AI (artificial intelligence) to perform deep learning. This ensures that scores for various evaluation items are calculated with improved accuracy. The following description is regarding a case that the drum playing proficiency is evaluated by performing processing using machine learning.

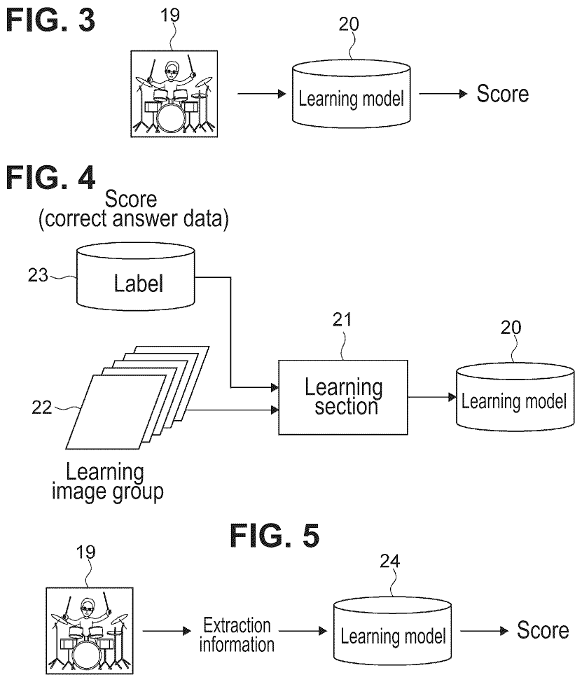

FIG. 3 is a schematic illustration of an example of calculating a score using a learning model. In the example illustrated in FIG. 3, machine learning is performed using a drum playing image 19 as input to estimate a score indicating the drum playing proficiency. Specifically, the drum playing image 19 is input into a learning model 20. The learning model 20 is a trained learning model that has undergone machine learning to estimate the drum playing proficiency. Then, a proficiency-indicating score is obtained from the learning model 20. By this processing, the drum playing proficiency is evaluated with improved accuracy. It is to be noted that scoring is not intended as limiting the way of evaluating the drum playing proficiency; it is possible to apply a learning model to any other way of evaluating the drum playing proficiency. Specifically, an arbitrary machine learning model that has undergone learning to estimate the drum playing proficiency may be used to show a general evaluation or an evaluation based on at least one evaluation item. It is to be noted that the learning model 20 can be referred to as machining learning model 20 or trained model 20.

FIG. 4 is a schematic illustration of how the learning model 20 learns using training data. As illustrated in FIG. 4, training data is input into a learning section 21 to train the learning model 20 to learn. The training data correlates learning data with training labels. The training data is data for training the learning model 20 to learn to estimate a correct answer in response to an input. As illustrated in FIG. 4, in this embodiment, the learning data input into the learning section 21 includes drum playing images 22. Also, training labels 23 are input into the learning section 21. The training labels 23 are proficiency-indicating scores. Each training label 23 serves as a correct answer (correct answer data) corresponding to a drum playing image 22, which is a training-purpose image.

In this embodiment, the training data correlates a drum playing image 22 (learning data), which is a training-purpose image, with a score (the training label 23). The learning model 20, therefore, is a prediction model that has undergone machine learning to learn the training data that includes the drum playing images 22 and proficiency-indicating scores. There is no limitation to the method of preparing training data (a data set of the drum playing images 22, which are training-purpose images, and scores). For example, the training data may be prepared manually. Another possible example is to obtain training data prepared in advance and input the training data into the learning section 21. It is to be noted that the scores (the training labels 23) used as the training data are correlated with various evaluation items related to drum playing. The learning model 20 is trained to learn such scores. Thus, by performing processing using machine learning, an evaluation based on each evaluation item is performed. That is, a score corresponding to each evaluation item is obtained from the learning model 20.

As illustrated in FIG. 4, the learning section 21 uses training data to train the learning model 20 to learn based on a machine learning algorithm. By this learning, a parameter (coefficient) used to calculate a correct answer (training label) is updated and generated as a trained parameter. A program incorporating the generated trained parameter is generated as the learning model 20.

A possible method of training the learning model to learn is error inverse propagation. Error inverse propagation (backpropagation) is a widely used learning method for neural network learning. As used herein, the term “neural network” is intended to mean a model with a three-layer structure made up of an input layer, an intermediate layer (hidden layer), and an output layer. This model is designed to simulate the network of neurons in the human brain. A neural network with a large number of intermediate layers is referred to as a deep neural network. A deep neural network is trained to learn by deep learning technology enabling the deep neural network to learn complicated patterns hidden in a large amount of data. Error inverse propagation is one way by which a deep neural network learns. For example, error inverse propagation is used for learning of a CNN, which is used to recognize still and moving images. This kind of machine learning may be implemented by a hardware structure, such as a neuro chip and neuromorphic chip, in which neural network concepts are incorporated.

There is no limitation to the algorithm to train the learning model 20 to learn; any machine learning algorithm may be used. Machine learning algorithm examples include a supervised learning algorithm, an unsupervised learning algorithm, a semi-supervised learning algorithm, a reinforcement learning algorithm, an inverse reinforcement learning algorithm, an active learning algorithm, and a transfer learning algorithm. Supervised learning is learning of feature quantities based on learning data (training data) with assigned labels. This ensures that labels assigned to unknown data can be introduced. In unsupervised learning, a large amount of learning data without labels is analyzed to extract feature quantities, and clustering is performed based on the extracted feature quantities. This ensures that trend analysis and/or future prediction can be performed based on a mass of unknown data. Semi-supervised learning is a mixture of supervised learning and unsupervised learning. Specifically, feature quantities are learnt in supervised learning, and a mass of training data is given in unsupervised learning so that learning is repeated while feature quantities are calculated automatically. In reinforcement learning, an agent observes a current state in an environment and learns to make decisions. The agent obtains a reward from the environment by selecting an action, and learns a strategy to obtain a largest sum of rewards through a series of actions. By learning an optimal solution in an environment, reinforcement learning enables computers to model human judgment capabilities and even exceed human judgment capabilities. Machine learning models such as HMM (Hidden Markov Model) and SVM (Support Vector Machine) may be used.

The learning model 20 generated by the learning section 21 is incorporated in the evaluator 17 illustrated in FIG. 1. Then, score estimation is performed by the evaluator 17. It is to be noted that the learning section 21 illustrated in FIG. 4 may be included in the information processing apparatus 15 so that the information processing apparatus 15 may train the learning model 20 to learn. It is also to be noted that the learning section 21 may be provided outside the information processing apparatus 15. That is, the learning section 21 may train the learning model 20 to learn in advance outside the information processing apparatus 15, and only the trained learning model 20 may be incorporated in the evaluator 17. Otherwise, there is no limitation to a specific configuration of the learning section 21 and a specific configuration of the learning section 21 regarding the training of the learning model 20 to learn.

It is to be noted that the machine learning algorithm may be applied to any processing in the present disclosure. That is, the processing using machine learning may be applied to any processing described in the present disclosure.

### Proficiency Evaluation Using Extraction Information

Extraction information is information extractable from the drum playing image 19. The proficiency of the performer 2 in drum playing may be evaluated using extraction information. Example of extraction information include at least one feature point related to drum playing, frame information regarding a frame of the performer 2 (frame information of the performer 2), the center of gravity of the performer 2, a facial expression of the performer, and a movement of the stick 3, which is used for drum playing.

An example of the at least one feature point related to drum playing is a predetermined body part of the performer 2, the drum set 4, or the stick 3. This feature point's position, motion (momentum), speed, and/or acceleration is extracted as extraction information. The feature point may be set to any predetermined part deemed appropriate. It is also possible to arbitrarily set a predetermined coordinate system to detect position information. Based on the frame information of the performer 2, the position, motion (momentum), speed, and/or acceleration of each part of the performer 2 may be obtained. Based on the center of gravity of the performer 2, the position of center of gravity, motion (momentum), displacement, speed, and/or acceleration may be obtained. It is to be noted that information regarding the center of gravity of the performer 2 may be obtained from the frame information. Based on the facial expression of the performer 2, it is possible to obtain information indicating whether the performer 2 is smiling or grimacing or whether the performer 2 maintains a composed facial expression. Based on the movement of the stick 3, which is used for drum playing, the position, motion (momentum), speed, and/or acceleration of each part of the stick 3 may be obtained. It is also possible to obtain information such as a pre-attack speed of the stick 3, a post-attack speed of the stick 3, and/or a difference between the pre-attack speed and the post-attack speed. The term “attack”, as used in the present disclosure, is intended to mean the moment at which the stick 3 strikes the drum to produce sound. Any other information extractable from the drum playing image 19 may be used as extraction information.

There is no limitation to the method of extracting extraction information from the drum playing image 19; any technique (algorithm) may be used. Possible examples of an image recognition technique include matching processing using a model image of an object, edge detection, and projective transformation. Another possible example is bone estimation. It is also possible to use existing externally built libraries with image processing, machine learning, and other functions. To extract extraction information, any machine learning algorithm may be used. For example, it is possible to perform semantic segmentation on the image information to determine the type of the object for each pixel of the image. By using extraction information, the drum playing proficiency is evaluated with improved accuracy.

FIG. 5 is a schematic illustration of an example of calculating a score using a learning model that takes, as input information, extraction information extracted from the drum playing image 19. As illustrated in FIG. 5, machine learning is performed with input being extraction information extracted from the drum playing image 19. In this manner, a score indicating the proficiency of the performer 2 in drum playing is estimated. The extraction information extracted from the drum playing image 19 is input into a the learning model 24. The learning model 24 has undergone the machine learning to estimate the drum playing proficiency. By inputting the extraction information into the trained the learning model 24, processing of obtaining a proficiency-indicating score from the machine learning model 28 is performed. This ensures that the drum playing proficiency is evaluated with improved accuracy.

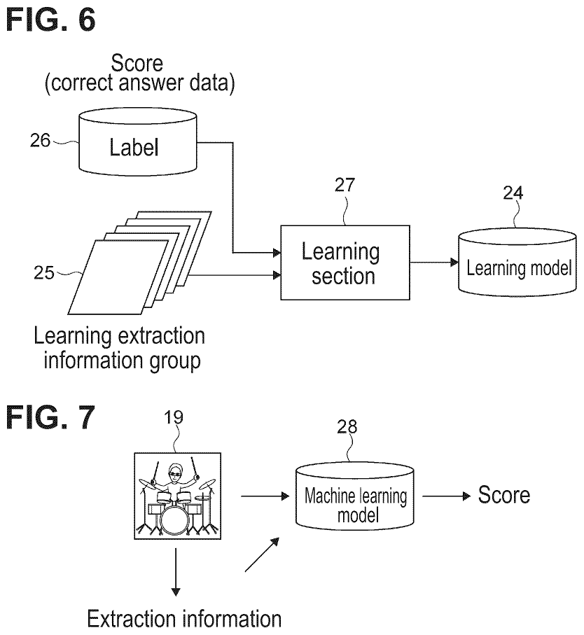

FIG. 6 is a schematic illustration of how the learning model 24 learns using training data. In this embodiment, extraction information 25 is used as learning data. The extraction information 25 is extracted from the drum playing image 19, which is a training-purpose image. Data that correlates this learning data with scores (training labels 26) is used as training data. Thus, the learning model 24 is a prediction model that has undergone machine learning with training data being the extraction information 25, which is extracted from the drum playing image 19, and the proficiency-indicating score. As illustrated in FIG. 6, a learning section 27 uses the training data to train the learning model 24 based on a machine learning algorithm. Thus, the learning model 24 is generated. There is no limitation to the algorithm to train the learning model 24; any machine learning algorithm may be used.

The scores (labels 26) used as the training data are correlated with various evaluation items related to drum playing. Such scores are learnt by the learning model 24. This ensures that an evaluation based on each evaluation item is performed by processing using machine learning. That is, a score corresponding to each evaluation item is obtained from the learning model 24. At this time, extraction information related to each evaluation item may be used to improve the accuracy of score estimation.

FIG. 7 is a schematic illustration of an example of calculating a score using a learning model that takes, as input information, both the drum playing image 19 and the extraction information. As illustrated in FIG. 7, machine learning is performed with input being both the drum playing image 19 and the extraction information extracted from the drum playing image 19. By performing such machine learning, a score indicating the proficiency of the performer 2 in drum playing is estimated. Both the drum playing image 19 and the extraction information extracted from the drum playing image 19 are input into a machine learning model 28. The machine learning model 28 has undergone the machine learning to estimate the drum playing proficiency. By inputting these pieces of information into the machine learning model 28, processing of obtaining a proficiency-indicating score from the machine learning model 28 is performed. This ensures that the drum playing proficiency is evaluated with improved accuracy.

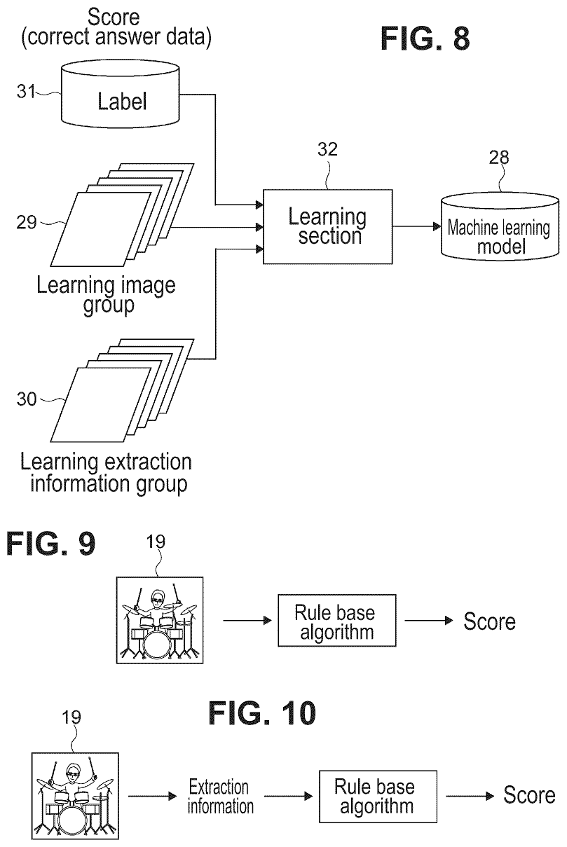

FIG. 8 is a schematic illustration of how the machine learning model 28 learns using training data. In this embodiment, a combination of a training-purpose drum playing image 29 and extraction information 30 extracted from the drum playing image 29 is used as learning data. Data that correlates this learning data with scores (training labels 31) is used as training data. Thus, the machine learning model 28 is a prediction model that has undergone machine learning to with training data being the combination of the drum playing image 29 and the extraction information 30 extracted from the drum playing image 29 and proficiency-indicating score. As illustrated in FIG. 8, a learning section 32 uses the training data to train the machine learning model 28 based on a machine learning algorithm. Thus, the machine learning model 28 is generated. There is no limitation to the algorithm to train the machine learning model 28; any machine learning algorithm may be used.

The scores (labels 31) used as the training data are correlated with various evaluation items related to drum playing. Such scores are learnt by the machine learning model 28. This ensures that an evaluation based on each evaluation item is performed by performing processing using machine learning. That is, a score corresponding to each evaluation item is obtained from the machine learning model 28. At this time, extraction information related to each evaluation item may be used to improve the accuracy of score estimation.

### Proficiency Evaluation (Processing Using Rule Base)

FIGS. 9 to 11 are schematic illustrations of proficiency evaluation performed by processing using a rule base. As illustrated in FIGS. 9 to 11, the evaluator 17 performs processing using a rule base to evaluate the proficiency of the performer 2 in drum playing.

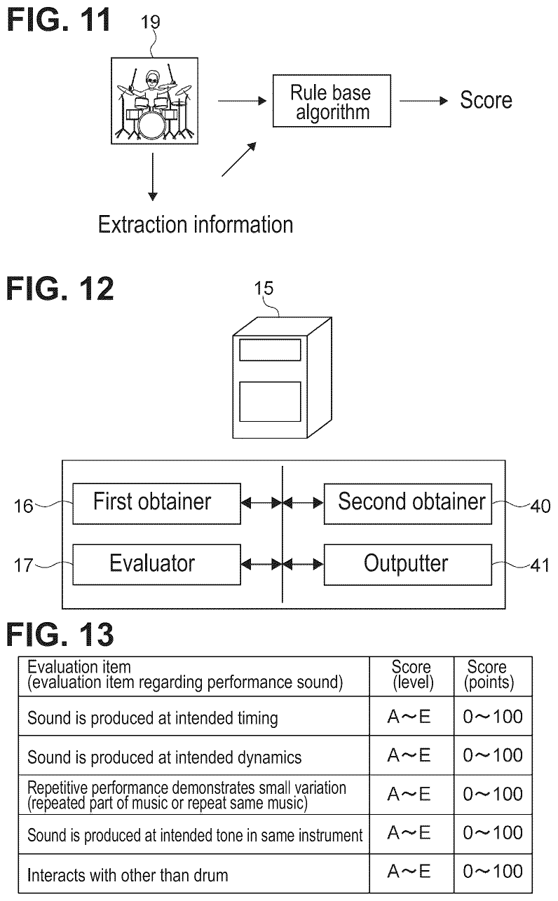

In the example illustrated in FIG. 9, a score indicating the proficiency of the performer 2 in drum playing is calculated by performing processing using a rule base algorithm with the drum playing image 19 as input. In the example illustrated in FIG. 10, a score indicating the proficiency of the performer 2 in drum playing is calculated by performing processing using a rule base algorithm with input being extraction information extracted from the drum playing image 19. In the example illustrated in FIG. 11, a score indicating the proficiency of the performer 2 in drum playing is calculated by performing processing using a rule base algorithm with input being both the drum playing image 19 and the extraction information extracted from the drum playing image 19.

Thus, an evaluation related to the proficiency of the performer 2 in drum playing is performed by rule base processing using at least one of the drum playing image 19 or the extraction information extracted from the drum playing image 19. It will be readily appreciated that scores may be calculated for various evaluation items related to drum playing. There is no limitation to a specific algorithm performed as rule base processing. Any rule base algorithm may be used such as matching technology, image recognition technology, and analysis technology.

### Proficiency Evaluation Using Detection Information/Supplemental Information

To evaluate the proficiency of the performer 2 in drum playing, it is possible to use information other than the drum playing image 19 and the extraction information extracted from the drum playing image 19. Possible examples of such information include detection information detected based on drum playing and supplemental information related to drum playing.

The detection information includes any information detected based on drum playing by the performer 2. Typically, the detection information is information detected by a detection device or apparatus different from the imaging apparatus 14. Examples of the detection device or apparatus include a microphone, a computer capable of retrieving and processing performance data such as a MIDI (which is a registered trademark and an abbreviation of Musical Instrument Digital Interface) data, a center of gravity locator, and a distance measuring sensor. Other examples of the detection device or apparatus include various wearable devices wearable by the performer 2 and various sensors incorporatable in the wearable devices. Specific examples include an IMU (Inertial Measurement Unit) sensor, a GPS sensor, and a biological sensor such as a temperature sensor. Another possible example is that an IMU sensor is mounted on the stick 3 as a detection device. Various kinds of detection information detected by these various detection devices and sensors may be used to evaluate the proficiency of the performer 2 in drum playing.

Examples of the detection information include sound information, performance time, performance tempo, sound production interval, movement of the performer 2, center of gravity of the performer 2, and the performer 2's body condition. The sound information is detected as audio data by, for example, a microphone. The sound information may also be detected as a MIDI (registered trademark) data. It is to be noted that sound information of another musical instrument played together with the drum set 4 may be detected as detection information. The performance time is detected as time from the start to the end of a musical performance. An example of the performance tempo is BPM (Beats Per Minute). The sound production interval is an interval between sound pieces of a musical performance. For example, the sound production interval is detected for each body part of the performer 2. Specifically, it is possible for the performer 2 to finely strike the hi-hat cymbal 10 with sixteenth notes using the right hand and strike the snare drum 6 with quarter notes using the left hand. In this case, the sound production interval for the right hand striking and the sound production interval for the left hand striking may be detected separately. That is, the detected information indicates that the sound production interval for the right hand striking is relatively short, while the sound production interval for the left hand striking is relatively long. The sound production interval for each body part of the performer 2 may be an average value in a predetermined performance time. Another possible example is a sound production interval that is statistically most frequent. The sound production interval for each body part of the performer 2 can also be referred to as a gap between sounds generated by each body part of the performer 2. The sound production interval for each body part of the performer 2 can also be referred to as information indicating the speed of performance movement of each body part of the performer 2.

The movement of the performer 2 may be detected in the form of position information indicating the position of each body part of the performer 2 or a displacement of the each body part on a predetermined coordinate system. For example, the acceleration, the speed, and/or the momentum of each body part of the performer 2 may be detected. The center of gravity of the performer 2 may be detected in the form of position information based on a predetermined coordinate system. The performer 2's body condition may be detected by a biological sensor. For example, a condition such as whether the performer 2's muscle is relaxed or tight may be detected as detection information.

There may be a case that information of a kind similar to the extraction information extracted from the drum playing image 19 is obtained as detection information. For example, a movement of the performer 2 based on the frame information of the performer 2 is obtained as extraction information. In contrast, a movement of the performer 2 is obtained as detection information detected by a wearable device worn by the performer 2. It is possible that such case occur. By using detection information, a score for each of the various evaluation items is calculated with improved accuracy.

The supplemental information includes various kinds of information to support the performer 2's drum playing. Examples of the supplemental information include correct performance information, past performance information, and information regarding another performance sound. The correct performance information includes information teaching what kind of musical performance to be played. Examples of such information include: musical score information indicating a musical score of the piece of music to be played; and information indicating a piece of music played at correct timings by the drums and cymbals included in the drum set 4. Other examples of such information include a numerical value of a correct performance tempo (BPM) and clicks (of a metronome) indicating a correct performance tempo. Another possible example of the correct information is a drum playing image of a highly proficient performer who is playing the drums so accurately that this playing can serve as a model. The past performance information includes performance information indicating a past playing of the same piece of music by the performer 2 or another performer. An example of the information regarding another performance sound is performance sound of another musical instrument (part) played together with the drum set 4. Other examples of the information regarding another performance sound include correct performance information of another musical instrument, real-time performance information of another musical instrument played together with the drum set 4, and past performance information of another musical instrument.

By using supplemental information, a score for each of the various evaluation items is calculated with improved accuracy. For example, by comparing the drum playing by the performer 2 with the correct performance information, the proficiency of the performer 2 in drum playing is evaluated. For another example, by comparing the drum playing by the performer 2 with the past performance information, the degree of improvement in drum playing is evaluated. There may be a case that information of a kind similar to the extraction information and/or the detection information is used as supplemental information.

FIG. 12 is a block diagram illustrating another exemplary functional configuration of the information processing apparatus 15. FIG. 12 illustrates a case that the proficiency of the performer 2 in drum playing is evaluated using the detection information and the supplemental information. In this case, a second obtainer 40 is provided in the information processing apparatus 15 as a functional block. The second obtainer 40 obtains at least one of the detection information or the supplemental information. The second obtainer 40 is similar to the first obtainer 16 and the evaluator 17 in that the second obtainer 40 is implemented by an element such as the CPU executing a predetermined program. It will be readily appreciated that dedicated hardware such as an IC (integrated circuit) may be used to implement the second obtainer 40.

### Evaluation Items Related to Drum Playing

FIGS. 13 to 15 are tables showing examples of at least one evaluation item related to drum playing. As illustrated in FIGS. 13 to 15, evaluation item examples include an evaluation item regarding a performance sound, an evaluation item regarding the movement of the stick 3, which is used for drum playing, and an evaluation item regarding the movement of the performer 2. For each of these evaluation items, the evaluator 17 performs processing using machine learning and/or processing using a rule base to calculate a proficiency-indicating score. This ensures that the drum playing proficiency is evaluated with improved accuracy. In the examples illustrated in FIGS. 13 to 15, each evaluation item is followed by one of five levels, A to E (level evaluation), and assigned a point ranging from 0 point to 100 point. It will be readily appreciated that there is no limitation to the method of score calculation and the evaluation method.

FIG. 13 illustrates evaluation item examples regarding a performance sound. Examples of the evaluation item regarding a performance sound include sound production timing control, sound dynamics control, tone control, repetitive performance stability, and a level of interaction with another performance sound. A score can be calculated for each of these evaluation items.

### Sound Production Timing Control

It is possible to evaluate how the performer 2 is controlling sound production timing. FIG. 13 exemplifies an evaluation item regarding whether sound is produced at an intended timing. An evaluation corresponding to this evaluation item is performed on a rhythm-changing part of a piece of music, such as a transition part from A melody to B melody or a hook-beginning part. The evaluation as to the sound production timing control, however, will not be limited to an evaluation on a rhythm-changing part. For example, the sound production timing control may be evaluated by analyzing the drum playing image 19 to determine whether repetitive striking is being performed uniformly or there is no variation in attack timing. Examples of the extraction information include frame information of the performer 2 and information regarding the movement of the stick 3. An example of the detection information is sound production information (sound information). Specifically, in a case that an electronic drum is played, a MIDI (registered trademark) data may be used. It will be readily appreciated that emission of sound of a normal drum may be obtained using a microphone or a similar device. Other examples of the detection information include a performance tempo and a movement of the performer 2. An example of the supplemental information is correct performance information. For example, the evaluation corresponding to this evaluation item may be performed using correct performance information such as MIDI (registered trademark) data, a musical score, a performance tempo, and a drum playing image serving as a model. There is no limitation to the information and parameters used to evaluate sound production timing control; any other information and parameters may be set arbitrarily.

It is to be noted that the extraction information, the detection information, and the supplemental information that have been described above as being usable have been presented for example purposes only; any other kind of the extraction information, the detection information, and the supplemental information may be used. The same applies in the other evaluation items described below.

### Sound Dynamics Control

It is possible to evaluate how the performer 2 is controlling sound dynamics. FIG. 13 exemplifies an evaluation item regarding whether the sound is produced at intended dynamics. For example, it is possible to evaluate whether how well the sound dynamics control is being performed in the performer 2's musical instrument alone. For another example, it is possible to evaluate how well the sound dynamics control is being performed in relation to (in order to maintain balance with) an other's musical instrument. It will be readily appreciated that a comprehensive evaluation combining these two viewpoints together may also be performed. For example, the sound dynamics control may be evaluated by analyzing the drum playing image 19 to determine stability of a movement pattern of the performer 2 (such as the range over which the performer 2's arm swings) or stability of a movement pattern of the stick 3 (such as the range over which the stick 3 swings). The evaluation corresponding to this evaluation item may also be performed based on information indicating whether the movement of the performer 2 or the movement of the stick 3 is close to a predetermined optimal pattern in a particular performance pattern (particular phrase). Examples of the extraction information include the frame information of the performer 2 and the movement of the stick 3. Examples of the detection information include sound production information and the movement of the performer 2. An example of the supplemental information is correct performance information. There is no limitation to the information and parameters used to evaluate the sound dynamics control; any other information and parameters may be set arbitrarily.

### Tone Control

It is possible to evaluate how the performer 2 is controlling tone. FIG. 13 exemplifies an evaluation item regarding whether the sound is being produced at an intended tone in the performer 2's musical instrument (the drum set 4). For example, the performer 2 may strike the center of the snare drum 6. The performer 2 may purposefully strike a part of the snare drum 6 off its center. The performer 2 may adjust depth (impact) of an open rimshot (rim knock or stick shot). The performer 2 may adjust where to strike the drum with the stick 3 in a closed rimshot. The performer 2 may adjust the position of strike on the hi-hat cymbal 10. The performer 2 may adjust the part of the stick 3 to hit the hi-hat cymbal 10. The performer 2 may adjust the opening degree of the hi-hat cymbal 10. The performer 2 is able to control tone using these playing techniques. The tone control may be evaluated by analyzing the drum playing image 19 to refer to information indicating the part of the drum or the cymbal being struck by the stick 3, information indicating the part of the stick 3 hitting the drum or the cymbal, information indicating a movement pattern of the performer 2 (such as the range over which the performer 2's arm swings), or information indicating a movement pattern of the stick 3 (such as the range over which the stick 3 swings). The evaluation corresponding to this evaluation item may also be performed based on a movement of the performer 2 and/or a movement of the stick 3 in a particular performance pattern (particular phrase). Examples of the extraction information include the frame information of the performer 2 and the movement of the stick 3. Examples of the detection information include the sound production information and the movement of the performer 2. An example of the supplemental information is correct performance information. There is no limitation to the information and parameters used to evaluate the tone control; any other information and parameters may be set arbitrarily.

### Repetitive Performance Stability

It is possible to evaluate how stable the performer 2's repetitive performance is. As used herein, the term “repetitive performance” is intended to mean repeating the same musical performance. Examples of a repetitive performance include a repeated part of a piece of music and playing a piece of music a plurality of times. FIG. 13 exemplifies an evaluation item regarding whether the repetitive performance demonstrates a small variation. The repetitive performance stability may be evaluated by analyzing the drum playing image 19 to determine stability of the movement pattern of the performer 2 (such as the range over which the performer 2's arm swings) in the repetitive performance or stability of the movement pattern of the stick 3 (such as the range over which the stick 3 swings) in the repetitive performance. Examples of the extraction information include the frame information of the performer 2 and the movement of the stick 3. Examples of the detection information include the sound production information and the movement of the performer 2. Examples of the supplemental information include correct performance information and past performance information. There is no limitation to the information and parameters used to evaluate the repetitive performance stability; any other information and parameters may be set arbitrarily.

### Interaction with Another Performance Sound

It is possible to evaluate the level of interaction between the performer 2 and another performance sound. A typical example of another performance sound is sound of another musical instrument. This, however, is not intended as limiting another performance sound. Another possible example is sound of the same kind of musical instrument played by another performer (dual drumming). FIG. 13 exemplifies an evaluation item regarding whether the performer 2 is interacting with a part other than the drum set 4. For example, there may be a case that the performer 2 cooperate with another performer (another performance sound) to introduce a purposeful fluctuation, a dissonance, an acceleration, a deceleration, or an improvisational alteration. It is possible to, based on the drum playing image 19, evaluate whether the performer 2 is interacting with another performance sound in the above-described various ways. An example of the extraction information is the facial expression of the performer 2. In a case that the drum playing image 19 includes another performer and/or another musical instrument, it is possible to: extract from the drum playing image 19 a facial expression of the another performer and/or a performance state of the another musical instrument; and use the extracted information in the evaluation as extraction information. Examples of the detection information include the sound production information, information regarding another performance sound, the movement of the performer 2, and a movement of another performer. Examples of the supplemental information include the correct performance information and the information regarding the another performance sound. There is no limitation to the information and parameters used to evaluate the level of interaction between the performer 2 and another performance sound; any other information and parameters may be set arbitrarily.

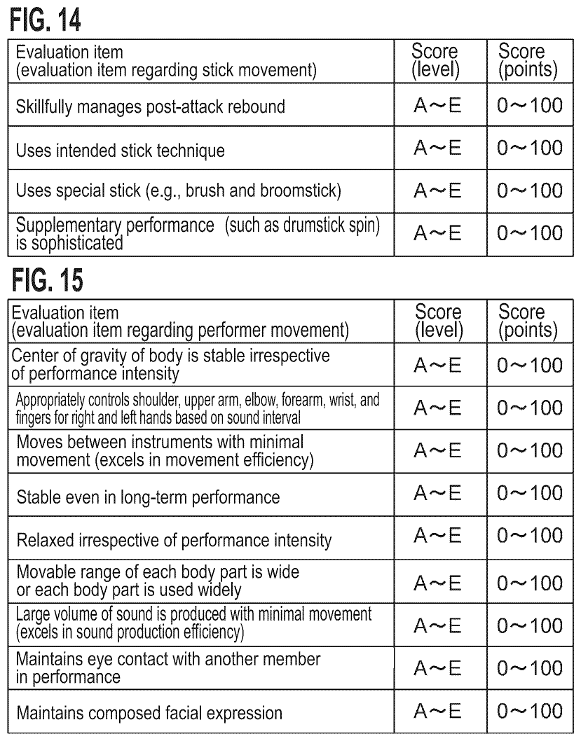

FIG. 14 illustrates evaluation item examples regarding the movement of the stick 3, which is used for drum playing. Examples of the evaluation items regarding the movement of the stick 3 include rebound control, stick technique accuracy, stick type usable to play the drum set 4, and supplementary performance accuracy. A score can be calculated for each of these evaluation items, and the drum playing proficiency is evaluated with improved accuracy using the scores.

### Rebound Control

It is possible to evaluate how the performer 2 is controlling the stick 3's rebound after the stick 3's attack. FIG. 14 exemplifies an evaluation item regarding whether how skillfully the performer 2 manages rebounds. For example, the rebound control may be evaluated by analyzing the drum playing image 19 to obtain a ratio of the post-attack speed of the stick 3 to the pre-attack speed of the stick 3. Specifically, when the performer 2 controls a rebound in relation to a full stroke or an upstroke, this control may be evaluated such that a higher score is given as “the post-attack speed of the stick 3/the pre-attack speed of the stick 3” is higher. When the performer 2 controls a rebound in relation to a down-stroke or a tap stroke, this control may be evaluated based on the ratio of the post-attack speed of the stick 3 to the pre-attack speed of the stick 3. The rebound control may also be evaluated based on the performer 2's pre-attack body condition and post-attack body condition in the drum playing image 19. Examples of the extraction information include the movement of the stick 3 and the frame information of the performer 2. An example of the detection information is sound production information. For example, the rebound control may be evaluated using information indicating whether a sound suitable for the stroke type is being produced. Other examples of the detection information include the movement of the performer 2 and the performer 2's body condition (such as whether the performer 2's muscle is relaxed or tight). An example of the supplemental information is correct performance information. There is no limitation to the information and parameters used to evaluate the rebound control; any other information and parameters may be set arbitrarily.

### Stick Technique Accuracy

It is possible to evaluate accuracy of various stick techniques (for example, single stroke, double stroke, paradiddle, ghost note, and roll). FIG. 14 exemplifies an evaluation item regarding whether an intended stick technique is used. For example, the stick technique accuracy may be evaluated based on the movement pattern of the stick 3 in the drum playing image 19. Examples of the extraction information include the movement of the stick 3 and the frame information of the performer 2. Examples of the detection information include sound production information, the movement of the performer 2, and the performer 2's body condition (such as whether the performer 2's muscle is relaxed or tight). An example of the supplemental information is correct performance information. There is no limitation to the information and parameters used to evaluate the stick technique accuracy; any other information and parameters may be set arbitrarily.

### Stick Type Usable in Performance

It is possible to evaluate whether the performer 2 is able to use a special stick 3 such as a brush and a broomstick, as well as a typical stick 3, in a performance. FIG. 14 exemplifies an evaluation item regarding whether the performer 2 is capable of using special sticks 3 in a performance. For example, the stick type that the performer 2 is capable of using in a performance may be evaluated by analyzing the drum playing image 19 to determine the type of the stick 3 used in the performance and the movement of each of the various sticks 3. An example of the extraction information is the movement of each of the various sticks 3 and the frame information of the performer 2. Examples of the detection information include sound production information, the movement of the performer 2, and the performer 2's body condition (such as whether the performer 2's muscle is relaxed or tight). An example of the supplemental information is correct performance information. There is no limitation to the information and parameters used to evaluate the stick type that the performer 2 is capable of using; any other information and parameters may be set arbitrarily.

### Supplementary Performance Accuracy

It is possible to evaluate the accuracy of a supplementary performance using the stick 3. An example of such supplementary performance is drumstick spin (twirling). FIG. 14 exemplifies an evaluation item regarding whether this supplementary performance is sophisticated. A supplementary performance using the stick 3 may seem a waste movement, not contributing to the whole performance. It is, however, possible to evaluate whether the performer 2 can mentally afford to make such waste movement and return to the primary drumming without disruption. For example, the supplementary performance accuracy may be evaluated by analyzing the drum playing image 19 to refer to the movement pattern of the performer 2 and the movement pattern of the stick 3. Examples of the extraction information include the movement of the stick 3 and the frame information of the performer 2. Examples of the detection information include sound production information, the movement of the performer 2, and the performer 2's body condition (such as whether the performer 2's muscle is relaxed or tight). An example of the supplemental information is correct performance information. There is no limitation to the information and parameters used to evaluate the supplementary performance accuracy; any other information and parameters may be set arbitrarily.

FIG. 15 exemplifies evaluation items regarding movements of the performer 2. Examples of the evaluation items regarding the movements of the performer 2 include: an evaluation item regarding a center of gravity, an evaluation item regarding a way of controlling the body of the performer 2, an evaluation item regarding performance stability, an evaluation item regarding a condition of the body of the performer in drum playing, an evaluation item regarding sound production efficiency, and an evaluation item regarding an interaction between the performer 2 and another performer

An example of the evaluation item regarding the center of gravity is stability of the center of gravity. Examples of the evaluation item regarding the way of controlling the body of the performer 2 include: a way of controlling the body of the performer 2 based on a sound production interval; and an efficient way of controlling the body of the performer 2. An example of the evaluation item regarding performance stability is long-term performance stability. Examples of the evaluation item regarding the condition of the body of the performer in drum playing include the presence or absence of a relaxed demeanor in a performance, the movable range of each of the body parts of the performer 2 in a performance, and whether the performer 2 maintains a composed facial expression. An example of the evaluation item regarding sound production efficiency is the sound production efficiency itself. An example of the evaluation item regarding the interaction between the performer and another performer is the presence or absence of eye contact with the other performer. A score can be calculated for each of these evaluation items, and the drum playing proficiency is evaluated with improved accuracy using the scores.

### Stability of Center of Gravity

It is possible to evaluate the stability of the center of gravity during the performer 2's drum playing. FIG. 15 exemplifies an evaluation item regarding whether the center of gravity of the performer 2's body is stable irrespective of performance intensity. It is of course possible to evaluate whether the center of gravity of the performer 2's body is stable without considering performance intensity. For example, the stability of the center of gravity may be evaluated by analyzing the drum playing image 19 to refer to information indicating whether the center of gravity of the performer 2 is moving or information indicating whether the center of gravity is moving in a regular pattern or randomly, in a case that the center of gravity is moving. For example, in a case that the center of gravity is moving in a regular pattern, the stability of the center of gravity can be evaluated as high. An example of the extraction information is the center of gravity of the performer 2. Examples of the detection information include sound production information and the center of gravity of the performer 2 (which can be obtained from, for example, a gravicorder). An example of the supplemental information is correct performance information. There is no limitation to the information and parameters used to evaluate the stability of the center of gravity; any other information and parameters may be set arbitrarily.

### Way of Controlling Body Based on Sound Production Interval

It is possible to evaluate the way of controlling the body of the performer 2 based on a sound production interval. FIG. 15 exemplifies an evaluation item regarding whether the performer 2 is appropriately controlling the performer 2's shoulder, upper arm, elbow, forearm, wrist, and fingers relative to each of the right hand and the left hand of the performer 2 based on a sound production interval. That is, whether the performer 2 is using the performer 2's body suitably relative to the right hand and the left hand based on the sound production interval is evaluated. For example, the way of controlling the body of the performer 2 based on a sound production interval may be evaluated based on the drum playing image 19 to refer to information regarding a predetermined body part of the performer 2. For example, in a case that the performer 2 chops the hi-hat cymbal 10 with sixteenth notes, the performer 2 preferably focus on the fingers as the sound production interval is shorter. In a case that the performer 2 strikes the snare drum 6 with quarter notes, the performer 2 preferably focus on the shoulder as the sound production interval is longer. Thus, when the performer 2 is capable of shifting focus between different body parts suitably based on the sound production interval, the performer 2 is highly evaluated (assigned a high) in the way of controlling the body of the performer 2. It will be readily appreciated that the way of controlling the body of the performer 2 may not necessarily be evaluated relative to the right hand or the left hand; it is possible to evaluate, based on a sound production interval, the way of controlling the body of the performer 2 relative to any other body part such as the right foot and the left foot. For example, in a case that the performer 2 plays the bass drum 5 using the right foot, it is possible to evaluate whether the performer 2 is using the performer 2's body parts such as groin, thigh, knee, calf, ankle, toe appropriately depending on whether the performer 2 plays the bass drum 5 fast (in a case of a short sound production interval) or slowly (in a case of a long sound production interval). Examples of the extraction information include the movement of the stick 3 and the frame information of the performer 2 (each body part's position, motion (momentum), speed, and/or acceleration). Examples of the detection information include sound production information, performance tempo, the movement of the performer 2 (each body part's position, motion (momentum), speed, and/or acceleration), and the performer 2's body condition. An example of the supplemental information is correct performance information (such as performance tempo). There is no limitation to the information and parameters used to evaluate the way of controlling the body of the performer 2 based on a sound production interval; any other information and parameters may be set arbitrarily.

### Efficient Way of Controlling Body

It is possible to evaluate an efficient way of controlling the body of the performer 2. FIG. 15 exemplifies an evaluation item regarding whether the performer 2 is moving between instruments with a minimal movement. That is, movement efficiency in a performance is evaluated. For example, whether the way of controlling the body of the performer 2 is efficient is evaluated by analyzing the drum playing image 19 to refer to information indicating a way of controlling the body for a particular performance pattern such as a tom fill. It is to be noted that the body of the performer 2 may not necessarily move over a shortest distance; when the body of the performer 2 moves with minimal labor that aligns with the body's anatomy, the performer 2 is highly evaluated. There are efficient ways of using the body known for drum playing, similarly to keyboard fingering. For example, an orthodox way is to perform tom fills using the right hand and the left hand alternately. As the performer 2 uses the body in a way closer to a way known as efficient, the performer 2 is highly evaluated. Examples of the extraction information include the frame information of the performer 2 and the movement of the stick 3. Examples of the detection information include sound production information, the movement of the performer 2, the performer 2's body condition. An example of the supplemental information is correct performance information. There is no limitation to the information and parameters used to evaluate an efficient way of controlling the body of the performer 2; any other information and parameters may be set arbitrarily.

### Long-term Performance Stability

It is possible to evaluate drum playing stability in a long-term performance. FIG. 15 exemplifies an evaluation item regarding whether the drum playing is stable even in a long-term performance. For example, the long-term performance stability may be evaluated by analyzing the drum playing image 19 to refer to the movement of the performer 2 over time, the performer 2's body condition, and the movement of the stick 3. It is also possible to evaluate the long-term performance stability by comparing the movement of the performer 2 at a certain point of time with the movement of the performer 2 at a predetermined later time. It is also possible to evaluate the long-term performance stability by comparing the movement of the stick 3 at a certain point of time with the movement of the stick 3 at a predetermined later time. Examples of the extraction information include the frame information of the performer 2 and the movement of the stick 3. Examples of the detection information include sound production information, performance tempo, the movement of the performer 2, the performer 2's body condition. An example of the supplemental information is correct performance information. There is no limitation to the information and parameters used to evaluate the long-term performance stability; any other information and parameters may be set arbitrarily.

### Presence or Absence of Relaxed Demeanor in Performance

It is possible to evaluate the presence or absence of a physically relaxed demeanor of the performer 2 while playing the drum set 4. That is, how the performer 2 is relaxed may be evaluated. FIG. 15 exemplifies an evaluation item regarding whether the performer 2 is relaxed irrespective of performance intensity. Drummers are not always relaxed throughout their drum playing; instead, drummers may occasionally exhibit intense on purpose in their drum playing. In light of this fact, it is possible to evaluate whether the performer 2 is relaxed at an appropriate time. For example, the performer 2 is highly evaluated in a case that the performer 2 is relaxed immediately after the attack or during a no-performance period. The presence or absence of a relaxed demeanor in a performance may be evaluated by, for example, analyzing the drum playing image 19 to refer to the movement of the performer 2, the performer 2's body condition, and/or the movement of the stick 3. For example, by determining whether the performer 2's muscle stiffens, the presence or absence of a relaxed demeanor or the degree of relaxation may be evaluated. Examples of the extraction information include the frame information of the performer 2 and the movement of the stick 3. Other examples of the detection information include the movement of the performer 2 and the performer 2's body condition (such as whether the performer 2's muscle is relaxed or tight). An example of the supplemental information is correct performance information. There is no limitation to the information and parameters used to evaluate the presence or absence of a relaxed demeanor in a performance; any other information and parameters may be set arbitrarily.

### Movable Range of Each Body Part in Performance

It is possible to evaluate the movable range of each of the body parts of the performer 2 while the performer 2 is playing the drum set 4. FIG. 15 exemplifies an evaluation item regarding whether the movable range of each of the body parts of the performer 2 is wide or whether the performer 2 is using each body part in a wide range. If a drummer holds the drummer's elbows away from the drummer's body while playing drums, the movable range of each body part becomes more limited. In light of this fact, a known basic concept is to keep the elbows close to the body while playing the drums. In light of this basic concept, it is possible to highly evaluate the performer 2 if the performer 2 keeps the elbows close to the body. It will be readily appreciated that various drumming techniques influence the movable range of each body part differently. For example, some drumming techniques favor keeping the elbows away from the body. In any of these cases, a standard for evaluation suitable for the intended drumming technique may be set. For example, it is possible to appropriately control the setting of scores included in the training data. This ensures that an evaluation that aligns with any of the various drumming techniques is performed. The same applies to the other evaluation items. The movable range of each of the body parts of the performer 2 in a performance may be evaluated by, for example, analyzing the drum playing image 19 to refer to the movement of the performer 2 and the performer 2's body condition. An example of the extraction information is the frame information of the performer 2. Examples of the detection information include sound production information, the movement of the performer 2, and the performer 2's body condition. An example of the supplemental information is correct performance information. There is no limitation to the information and parameters used to evaluate the movable range of each of the body parts of the performer 2 in a performance; any other information and parameters may be set arbitrarily.

### Sound Production Efficiency

It is possible to evaluate sound production efficiency of drum playing. FIG. 15 exemplifies an evaluation item regarding whether a large volume of sound is produced with a minimal movement. For example, the performer 2 is highly evaluated in terms of sound production efficiency in a case that a large volume of sound is produced with a minimal movement. It is possible to analyze the drum playing image 19 to refer to the movement of the performer 2 and the performer 2's body condition. Then, it is possible to detect sound information as detection information to evaluate the sound production efficiency. An example of the extraction information is the frame information of the performer 2. Other examples of the detection information include the movement of the performer 2 and the performer 2's body condition. An example of the supplemental information is correct performance information. There is no limitation to the information and parameters used to evaluate the sound production efficiency; any other information and parameters may be set arbitrarily.

### Presence or Absence of Eye Contact With Another Performer

It is possible to evaluate the presence or absence of eye contact with another performer. FIG. 15 exemplifies an evaluation item regarding whether the performer 2 maintains eye contact with another member in a performance. Generally, if a performer maintains eye contact with other members in a performance, this can have a reassuring effect on the audience and often suggests that the performer is highly proficient. Also, a performer maintaining eye contact with other members often demonstrates an awareness of the surroundings. In light of this, the performer 2 is highly evaluated in a case that the performer 2 maintains eye contact with another member. For example, the presence or absence of eye contact with another performer may be evaluated by analyzing the drum playing image 19 to refer to the movement and orientation of the face of the performer 2. In a case that another performer is included in the drum playing image 19, the movement and orientation of the face of the other performer may also be utilized to evaluate the presence or absence of eye contact. Examples of the extraction information include the frame information of the performer 2 and the facial expression of the performer 2. In a case that another performer is included in the drum playing image 19, the facial expression or other characteristics of the other performer may be extracted as extraction information and used in the evaluation. Examples of the detection information include the movement of the performer 2 and the movement of the other performer. Examples of the supplemental information include correct performance information and information regarding the other performer's sound. There is no limitation to the information and parameters used to evaluate the presence or absence of eye contact with the other performer; any other information and parameters may be set arbitrarily.

### Whether Performer Maintains Composed Facial Expression

It is possible to evaluate whether the performer 2 playing the drum set 4 maintains a composed facial expression. FIG. 15 exemplifies an evaluation item regarding whether the performer 2 maintains a composed facial expression. For example, in a case that there is no sign of tension on the face (such as a grimace), specifically, if the performer 2 is smiling or the performer 2's open mouth suggest composure, then the performer 2 is determined as maintaining a composed facial expression and highly evaluated. For example, whether the performer 2 maintains a composed facial expression may be evaluated by analyzing the drum playing image 19 to refer to the facial expression of the performer 2. An example of the extraction information is the facial expression of the performer 2. An example of the detection information is the movement of the performer 2. An example of the supplemental information is correct performance information. There is no limitation to the information and parameters used to evaluate whether the performer 2 maintains a composed facial expression; any other information and parameters may be set arbitrarily.

It is also possible to assign scores based on various other evaluation items, in addition to the evaluation items shown in the tables of FIGS. 13 to 15. For example, the drum playing proficiency may be evaluated based on the movement of the foot stepping on the pedal of the hi-hat cymbal 10. There may be a case that a performer maintains a rhythm by moving the foot stepping on the pedal of the hi-hat cymbal 10 (without opening and closing the hi-hat cymbal 10). In this case, if the movement of the performer 2 maintaining a rhythm is accurate, the performer 2 is highly evaluated. If the movement of the foot stepping on the pedal of the hi-hat cymbal 10 is out of habit and random, the performer 2 is evaluated poorly. In a case that the performer 2 is playing the drum set 4 with the foot stepping on the pedal of the hi-hat cymbal 10 in stationary state, the performer 2 is highly evaluated. Such types of evaluation are also possible. There may be a case that the performer 2 counts at the beginning of a piece of music using the stick 3. In this case, it is possible to establish an evaluation item regarding the accuracy of the counting. If the counting is accurate, the performer 2 is highly evaluated.

### Output of Evaluation Result and Assist Information

The information processing apparatus 15 is capable of outputting a score calculated as an evaluation result for each of the evaluation items. The information processing apparatus 15 is also capable of outputting assist information for improving the drum playing proficiency. With the assist information, the performer 2 is able to efficiently improve the performer 2's proficiency in drum playing. In a case that a score and assist information are output, an outputter 41 is established as a functional block, as exemplified in FIG. 12. The outputter 41 is similar to the first obtainer 16, the evaluator 17, and the second obtainer 40 in that the outputter 41 is implemented by an element such as the CPU executing a predetermined program. It will be readily appreciated that dedicated hardware such as an IC (integrated circuit) may be used to implement the outputter 41.

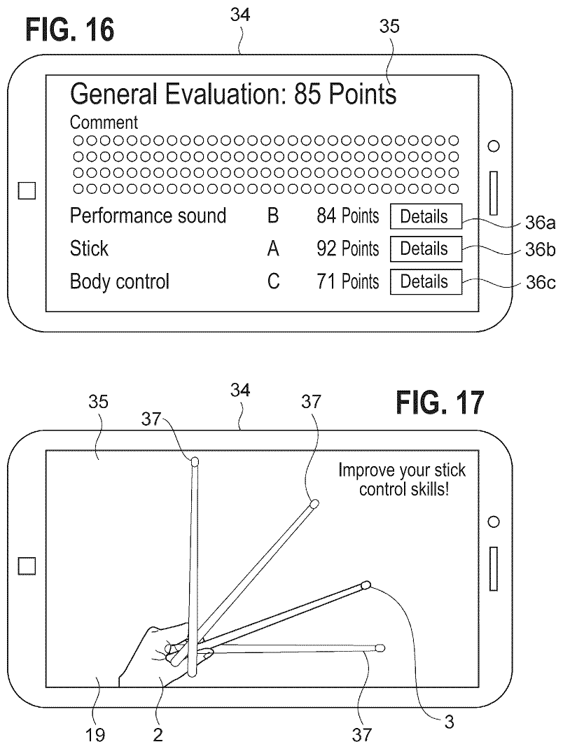

FIGS. 16 and 17 each are a schematic illustration of an example in which an evaluation result and assist information are output. FIGS. 16 and 17 illustrate a case that a smartphone 34 is used as one embodiment of the information processing apparatus according to the present disclosure. The smartphone 34 serves as a device that integrates the imaging apparatus 14 and the information processing apparatus 15 illustrated in FIG. 1. That is, the smartphone 34 serves as a computer with an imaging function.

For example, the performer 2 downloads an application (application program) into the smartphone 34 to use the drum practice assist system 1. Then, the performer 2 inputs information such as ID (identification) and password to create an account to use the drum practice assist system 1. There may be a case that it is not necessary to create an account.

The performer 2 takes an image of the performer 2's drum playing using a camera incorporated in the smartphone 34. For example, the performer 2 places the smartphone 34 in front of the drum set 4 and starts imaging in video mode. Then, the performer 2 plays the drum set 4, and takes an image of the drum playing using the smartphone 34. Alternatively, the performer 2 practices drum playing using a practice kit such as a practice pad, and takes an image of the practice using the smartphone 34. Thus, the performer 2 is able to take an image of drum playing practice as a drum playing image. It will be readily appreciated that another person may take an image of the performer 2's drum playing.

The performer 2 activates the application to use the drum practice assist system 1 and inputs the obtained drum playing image into the application. There is no limitation to the GUI (Graphical User Interface) and the method for inputting the drum playing image into the application; any type of GUI and any method may be used.

The first obtainer 16 illustrated in, for example, FIG. 12 inputs the drum playing image obtained from the performer 2. The evaluator 17 evaluates the proficiency of the performer 2 in drum playing by performing the machine learning processing exemplified in FIGS. 3 to 8 and the rule base processing exemplified in FIGS. 9 to 11. For example, a score is calculated for each of the evaluation items exemplified in FIGS. 13 to 15. When the score is calculated, the second obtainer 40 may obtain detection information and/or supplemental information for use in the evaluation of each evaluation item. Then, the outputter 41 outputs the evaluation result and the assist information. For example, the evaluation result and the assist information is output in the form of an image or sound.

In the example illustrated in FIG. 16, the evaluation result displayed on a touch panel 35 of the smartphone 34 includes a general-evaluation score “B” and “85 points” displayed to the right of the text “General Evaluation”. The evaluation result also includes a general-evaluation score for the evaluation item regarding performance sound displayed to the right of the text “Performance Sound” (“B” and “84 points”) To refer to detail scores of the evaluation item regarding performance sound, an item button 36a is selected, switching to a screen displaying the detail scores of this evaluation item. The evaluation result also includes a general-evaluation score for the evaluation item regarding the movement of the stick 3, which is used for drum playing, displayed to the right of the text “Stick” (“A” and “94 points”). To refer to detail scores of the evaluation item regarding the movement of the stick 3, which is used for drum playing, an item button 36b is selected, switching to a screen displaying the detail scores of this evaluation item. The evaluation result also includes a general-evaluation score for the evaluation item regarding the movement of the performer 2 displayed to the right of the text “Way of Controlling Body” (“C” and “71 points”). To refer to detail scores of the evaluation item regarding the movement of the performer 2, an item button 36c is selected, switching to a screen displaying the detail scores of this evaluation item. The image (screen) of the detail scores of each evaluation item may be displayed in the tabular format illustrated in FIGS. 13 to 15. Otherwise, any configuration may be employed.

Also in the example illustrated in FIG. 16, a general evaluation comment is displayed under the text “General Evaluation”. The general evaluation comment is assist information. Examples of the evaluation comment include “That was rough. Keep practicing.” and “Great stick control! Now, try to focus on your posture and body movement.” It will be readily appreciated that these examples of the evaluation comment are not intended in a limiting sense; any other comments may be displayed. It is also possible that the evaluation comment is read aloud in the form of sound.

In the example illustrated in FIG. 17, a virtual image 37 is displayed as assist information. The virtual image 37 is an image also referred to as an AR (Augmented Reality) image superimposed onto a real object. In FIG. 17, the drum playing image 19 shows the performer 2's left hand and the stick 3 held by the left hand, and the virtual image 37 shows a virtual image of the stick 3. The virtual image 37 is superimposed onto the drum playing image 19, which is a real object. For example, the virtual image 37 of the stick 3 demonstrates an accurate up stroke movement as assist information for improving stick control. Thus, the virtual image 37 may be displayed to show a correct movement of the stick 3 (a movement gaining a high score) or a correct movement of the performer 2's body to teach the performer 2 the correct movement of the stick 3 or the correct movement of the performer 2's body. That is, examples the virtual image 37, which is superimposed onto a real object, include a virtual image 37 of the movement of the stick 3, which is used for drum playing, and a virtual image 37 of the movement of the performer 2. This enables the performer 2 to intuitively understand the correct movement to aim at and improve the proficiency of the performer 2 efficiently. It is to be noted that the example illustrated in FIG. 17 may also be regarded as an AR representation in which the virtual image 37 of the stick 3 is superimposed onto the performer 2's left hand and the stick 3, which are real objects. It will be readily appreciated that a virtual image may be displayed as assist information in a manner in which the virtual image is not superimposed onto a real object. For example, a virtual image of the stick 3 or the performer 2's body making a correct movement may be displayed without being superimposed onto a real object. In this case as well, the performer 2 is able to understand the correct movement of the stick 3 or the correct movement of the performer 2's body by viewing the virtual image.

It will be assumed that an AR glass is used as one embodiment of the information processing apparatus according to the present disclosure. An example of the AR glass is an HMD (Head-Mounted Display) mountable on the head of the performer 2. In this case, an evaluation result and assist information may be displayed on a display section of the AR glass. For example, a virtual image 37 of the performer 2's body or the stick 3 may be superimposed as assist information onto real objects such as the performer 2's body, the stick 3, and the drum set 4 with these real objects included within the field of vision of the performer 2 at playing position. Another possible example is that the taking of the drum playing image 19, the performing of the evaluation based on each evaluation item, and the outputting of the evaluation result and assist information (such as an evaluation comment and a virtual image 37) are performed in real-time as the drum playing proceeds.

It will be assumed that a VR glass is used as one embodiment of the information processing apparatus according to the present disclosure. An example of the VR glass is an HMD (Head-Mounted Display) mountable on the head of the performer 2. In this case, an evaluation result and assist information may be displayed on a display section of the VR glass. For example, a 3D model image of the playing performer 2's body, the stick 3, and the drum set 4 is displayed as a virtual image (VR image). For example, the 3D model image may show the performer 2 dressed in an outfit identical to the outfit of a favorite musician. For another example, the 3D model image may show a person resembling a favorite musician himself/herself. For another example, the 3D model image may show such a VR representation that the performer 2 performs in a famous concert venue or a famous hall filled with audience. It is also possible to display, as assist information, a virtual image (VR image) that serves as a model teaching a correct movement in a predetermined VR space. An example of such assist information a 3D model image of the stick 3 and the performer 2's body. It will be readily appreciated that such virtual image serving as assist information may be superimposed onto a virtual image of the performer 2 or the stick 3. In the case of a VR glass as well, the taking of the drum playing image 19, the performing of the evaluation based on each evaluation item, and the outputting of the evaluation result and assist information (such as an evaluation comment and a virtual image 37) may be performed in real-time as the drum playing proceeds.

The assist information will not be limited to the comment related to the proficiency illustrated in FIG. 16 and the virtual image 37, which is superimposed onto a real object, as illustrated in FIG. 17; it is possible to output any other various assist information. For example, a history of proficiencies evaluated in the past may be displayed. Specifically, a score history may be displayed for each of the evaluation items. This enables the performer 2 to check the performer 2's improvements. That is, by visualizing the performer 2's improvements, the performer 2 feels more motivated to continue practicing. The visualization also enables the performer 2 to identify areas of decline and weaknesses. This enables the performer 2 to create a more effective practice plan.

As has been described hereinbefore, the drum practice assist system 1 and the information processing apparatus 15 according to this embodiment evaluate the proficiency of the performer 2 in drum playing based on the drum playing image 19. This enables the performer 2 to efficiently improve the performer 2's proficiency in drum playing. For example, the proficiency on each of the various evaluation items is evaluated highly accurately using a high-performance imaging apparatus 14 and another detection device. In contrast, the drum practice assist system 1 may be used more casually using the single smartphone 34, as described above by referring to FIGS. 16 and 17. This enables the drum playing proficiency to improve in an effective way that aligns with the level of each of a wide range of performers 2, from a professional drummer to an amateur drummer (including a beginner). As a result, more individuals are attracted to try playing the drums, leading to increased popularity of drumming and a higher overall level of drumming skills.

In the previous embodiment, a way of controlling the body of the performer 2 based on a performance tempo may be used as an evaluation item regarding the movement of the performer 2. For example, whether the performer 2 is appropriately controlling the performer 2's shoulder, upper arm, elbow, forearm, wrist, and fingers based on BPM may be used as an evaluation item. For example, the way of controlling the body of the performer 2 based on a performance tempo may be evaluated by analyzing the drum playing image 19 to refer to information indicating a body part of the performer 2 mainly used for drum playing. It is also possible to obtain the BPM itself from a movement of the performer 2 or a movement of the stick 3 extracted from the drum playing image 19.

In the previous embodiment, it is possible to evaluate a movement of each body part of the performer 2 relative to a performance tempo. That is, an evaluation may be performed for each body part of the performer 2. For example, an evaluation may be performed individually for a relationship between a shoulder motion and a performance tempo, a relationship between an upper arm motion and the performance tempo, a relationship between an elbow motion and the performance tempo, a relationship between a forearm motion and the performance tempo, a relationship between a wrist motion and the performance tempo, and a relationship between a finger motion and the performance tempo. This ensures that the way of controlling the body of the performer 2 based on a performance tempo is evaluated in detail for each body part of the performer 2. As a result, the drum playing proficiency is evaluated with improved accuracy.

For example, it is possible to evaluate a movement of each body part of the performer 2 relative to a performance tempo by performing processing using the machine learning exemplified in FIGS. 3 to 8. In this case, in order to evaluate the relationship between each body part of the performer 2 and the performance tempo, a learning model may be constructed for each body part of the performer 2. For example, it is possible to construct a first learning model to evaluate a relationship between a body part 1 (shoulder information) and the performance tempo, a second learning model to evaluate a relationship between a body part 2 (upper arm information) and the performance tempo, and a third learning model to evaluate a relationship between a body part 3 (elbow information) and the performance tempo. That is, it will be assumed that the body of the performer 2 is hypothetically divided into n parts. Thus, it is possible to construct n learning models to evaluate the relationship between the performance tempo and each of the n body parts of the performer 2. It will be readily appreciated that it is possible to construct a learning model to evaluate a relationship between the performance tempo and the upper half of the body or construct a learning model to evaluate a relationship between the performance tempo and the lower half of the body.

In the previous embodiment, it is possible to output assist information related to a movement of each body part of the performer 2 based on a performance tempo. An example of such assist information is that instructs how to move each body part of the performer 2 based on a predetermined performance tempo. That is, a correct movement (movement gaining a high score) based on a performance tempo may be output for each body part of the performer 2. It will be readily appreciated that a virtual image 37 may be superimposed onto each real-object body part of the performer 2. For example, a virtual image 37 of a shoulder making a correct movement is superimposed onto an actual shoulder of the performer 2. Such virtual image 37 may be displayed for each body part of the performer 2.

A detailed evaluation for each body part of the performer 2 may be performed as an evaluation of the way of controlling the body of the performer 2 based on a sound production interval. For example, in a case that the performer 2 finely strikes the hi-hat cymbal 10 using the right hand, it is possible to perform an evaluation as to control of the performer 2's shoulder, upper arm, elbow, forearm, wrist, and fingers relative to the right hand. Similarly, in a case that the performer 2 tightly strikes the snare drum 6 using the left hand, it is possible to perform an evaluation as to control of the performer 2's shoulder, upper arm, elbow, forearm, wrist, and fingers relative to the left hand. In order to evaluate the relationship between each body part of the performer 2 and the sound production interval, a learning model may be constructed for each body part of the performer 2. It is also possible to output assist information related to a movement of each body part of the performer 2 based on a sound production interval.

It is possible to add information indicating reliability to the evaluation result (score) obtained for each evaluation item. For example, there may be a case that a highly accurate evaluation is expected from some evaluation items due to the content shown in the drum playing image 19, whereas a less accurate evaluation is only expected from other evaluation items due to the content shown in the drum playing image 19. Specifically, there may be a case that the drum playing image 19 is highly accurate only in the area from the shoulder to the tip of the fingers and in the entire area of the stick 3, and that the performer 2 making the attack is clearly seen with the face of the performer 2 substantially invisible. In this case, a score is calculated highly accurately for the evaluation item exemplified in FIG. 14 regarding the movement of the stick 3, which is used for drum playing. This evaluation result (score), therefore, is assigned a high level of reliability. In contrast, a score is calculated less accurately for the evaluation items exemplified in FIG. 15, such as the presence or absence of eye contact with another performer and whether the performer 2 maintains a composed facial expression. These evaluation items, therefore, are assigned a low level of reliability. Thus, the evaluation results may be assigned a level of reliability. This enables the performer 2 to obtain more valuable evaluation results to help improve the performer 2's drum playing proficiency more effectively.

FIG. 18 is a block diagram illustrating an example hardware configuration of a computer 60. The computer 60 can be used as the information processing apparatus 15. The computer 60 includes a CPU 61, a ROM (Read Only Memory) 62, a RAM 63, an Input-Output interface 65, and a bus 64. The bus 64 connects these elements to each other. The Input-Output interface 65 is connected with elements such as a display section 66, an input section 67, a storage section 68, a communication section 69, and a drive section 70. The display section 66 is a display device using material such as liquid crystal and EL (Electroluminescence). The input section 67 is an operation device such as a keyboard, a pointing device, and a touch panel. In a case that the input section 67 includes a touch panel, the touch panel may be integral to the display section 66. The storage section 68 is a nonvolatile storage device, examples including an HDD and a solid-state memory such as a flash memory. The drive section 70 is a device capable of driving a removable storage medium 71. Examples of the storage medium 71 include an optical storage medium and a magnetic recording tape. The communication section 69 is a modem, a router, or any other communication device that is connectable a LAN (local area network) and/or a Wide Area Network (WAN) and that is communicable with other devices. The communication section 69 may communicate with other devices through a wire or wirelessly. The communication section 69 is in many cases used in a form separate from the computer 60. With the above-described hardware configuration, the computer 60 performs information processing through a collaborative operation of software stored in the storage section 68 or the ROM 62 and the hardware resources of the computer 60. Specifically, a program constituting the software stored in a storage such as the ROM 62 is loaded and executed in the RAM 63 to implement the method for processing information according to the present disclosure. The program is installed in the computer 60 via, for example, the storage medium 71. Another possible example is that the program is installed in the computer 60 via a network such as a global network. Another possible example is to use any non-transitory computer-readable storage medium.

In the previous embodiment, a plurality of computers connected to each other communicatively via a network or by any other wired or wireless method may cooperate to perform the program according to the present disclosure and the method for processing information according to the present disclosure (specifically, a drum practice assist method and a proficiency evaluation method). The information processing apparatus according to the present invention may be constructed in this manner. That is, the method for processing information according to the present disclosure and the program according to the present disclosure can be performed not only by a computer system made up of a single computer but also by a computer system made up of a plurality of cooperating computers. In the present disclosure, the term “system” is intended to mean a collection of a plurality of elements or components, such as apparatuses, devices, modules (including parts and members). This definition applies irrespective of whether all the elements or components are housed within the same enclosure. Specifically, a plurality of apparatuses or devices connected to each other via a network and housed within separate enclosures make up a system; and a single apparatus or device with a plurality of modules housed within a single enclosure is a system. The computer system-implemented method for processing information according to the present disclosure and the computer system-implemented program according to the present disclosure encompass a case that a single computer obtains a drum playing image, evaluates the drum playing proficiency, extracts extraction information, obtains detection information, obtains supplemental information, and outputs a score and assist information; and a case that different computers perform these processings. In a case that a predetermined computer performs these processings, the predetermined computer may cause another computer to perform one, some, or all of the processings to obtain a result of the one, some, or all of the processings. This configuration is encompassed within the computer system-implemented method for processing information according to the present disclosure and the computer system-implemented program according to the present disclosure. That is, the program and method for processing information according to the present disclosure is applicable to a cloud computing configuration in which a plurality of apparatuses or devices cooperate via a network to perform a single function.

The drum playing assist system, the information processing apparatus, the smartphone, the GUI to output evaluation results and/or assist information, and the flows of processings for evaluating the drum playing proficiency have been described above by referring to the accompanying drawings. The above-described systems, apparatuses, devices, modules, and processings have been presented only for the purpose of illustration and description, and it is to be understood that various changes, modifications, and rearrangements can be made without departing from the concept of the present disclosure. That is, the present disclosure will not be limited to the specific configurations or algorithms described herein; it is to be understood that other configurations or algorithms can be employed without departing from the concept of the present disclosure.

In the present disclosure, approximating language such as “approximately”, “about”, and “substantially” may be applied to modify any quantitative representation that could permissibly vary without a significant change in the final result obtained. That is, terms that describe shape, size, position, and condition are employed in the present disclosure, including “center”, “middle”, “uniform”, “equal”, “same”, “orthogonal”, “parallel”, “symmetry”, “extending”, “axial”, “solid-cylindrical”, “hollow-cylindrical”, “ring-shaped”, and “toroidal”. All these terms recited in the present application shall be construed to be modified by approximating language such as “approximately”, “about”, and “substantially”; for example, “substantially center”, “substantially middle”, “substantially uniform”, “substantially equal”, “substantially same”, “substantially orthogonal”, “substantially parallel”, “substantially symmetry”, “substantially extending”, “substantially axial”, “substantially solid-cylindrical”, “substantially hollow-cylindrical”, “substantially ring-shaped”, and “substantially toroidal”. For example, the terms “center”, “middle”, “uniform”, “equal”, “same”, “orthogonal”, “parallel”, “symmetry”, “extending”, “axial”, “solid-cylindrical”, “hollow-cylindrical”, “ring-shaped”, and “toroidal” shall be construed as being within 10% deviation from a state of “completely center”, “completely center”, “completely uniform”, “completely equal”, “completely similar”, “completely orthogonal”, “completely parallel”, “completely symmetry”, “completely extending”, “completely axial”, “completely solid-cylindrical”, “completely hollow-cylindrical”, “completely ring-shaped”, and “completely toroidal”, respectively. Thus, terms not modified by approximating language such as “approximately”, “about”, and “substantially” shall be construed to be modified by approximating language such as “approximately”, “about”, and “substantially”. It is to be noted, however, that terms modified by approximating language such as “approximately”, “about”, and “substantially” may not necessarily exclude a complete state.

In the present disclosure, comparative expressions using “than”, such as “larger than A” and “smaller than A”, shall be construed to comprehensively include both a case of “equal to A” and a case excluding “equal to A”. For example, the expression “larger than A” includes not only a case excluding “equal to A” but also a case of “A or more”. For another example, the expression “smaller than A” includes not only a case of “less than A” but also a case of “A or less”. In order to maximize the effects of the present disclosure, specific settings may be adjusted as necessary based on the concepts of “larger than A” and “smaller than A” described above.

It is possible to combine at least two features of the above-described features of the embodiment. That is, the various features described in the embodiment may be combined in any manner, irrespective of their original embodiment. It will be readily appreciated that the various effects described above have been presented solely for illustration and description; the embodiment may produce other effects not explicitly illustrated herein.

What is claimed is:

1. An information processing apparatus comprising:
a first obtainer configured to obtain an image of a performer playing a drum; and
an evaluator configured to, based on the image obtained by the first obtainer, evaluate a proficiency of the performer in playing the drum.

2. The information processing apparatus according to claim 1, wherein into a trained learning model that has undergone machine learning to estimate the proficiency, the evaluator is configured to input at least one of the image or extraction information extracted from the image to obtain a score indicating the proficiency from the learning model.

3. The information processing apparatus according to claim 2, wherein the extraction information includes at least one of at least one feature point related to playing of the drum, frame information regarding a frame of the performer, a center of gravity of the performer, a facial expression of the performer, or a movement of a stick used to play the drum.

4. The information processing apparatus according to claim 1, wherein the evaluator is configured to evaluate the proficiency based on extraction information extracted from the image.

5. The information processing apparatus according to claim 1, wherein
the evaluator is configured to calculate a score indicating the proficiency for each of at least one evaluation item used to evaluate playing of the drum, and
the at least one evaluation item includes at least one of an evaluation item regarding a performance sound, an evaluation item regarding a movement of a stick used to play the drum, or an evaluation item regarding a movement of the performer.

6. The information processing apparatus according to claim 5, wherein the evaluation item regarding the performance sound includes at least one of sound production timing control, sound dynamics control, tone control, repetitive performance stability, or a level of interaction between the performer and another performance sound.

7. The information processing apparatus according to claim 5, wherein the evaluation item regarding the movement of the stick used to play the drum includes at least one of rebound control, stick technique accuracy, a stick type that the performer is capable of using to play the drum, and supplementary performance accuracy.

8. The information processing apparatus according to claim 5, wherein the evaluation item regarding the movement of the performer includes at least one of an evaluation item regarding a center of gravity of the performer, an evaluation item regarding a way of controlling a body of the performer, an evaluation item regarding performance stability, an evaluation item regarding a condition of the body of the performer in the playing of the drum, an evaluation item regarding sound production efficiency, or an evaluation item regarding an interaction between the performer and another performer.

9. The information processing apparatus according to claim 1, wherein the evaluator is configured to evaluate a movement of each of body parts of the performer relative to a performance tempo.

10. The information processing apparatus according to claim 9, wherein the evaluator is configured to perform processing using machine learning to evaluate the movement of each of the body parts of the performer.

11. The information processing apparatus according to claim 9, further comprising an outputter configured to output assist information regarding the movement of each of the body parts of the performer relative to the performance tempo.

12. The information processing apparatus according to claim 1, further comprising a second obtainer configured to obtain at least one of detection information detected based on playing of the drum or supplemental information related to the playing of the drum, wherein the evaluator is configured to evaluate the proficiency using at least one of the detection information or the supplemental information obtained by the second obtainer.

13. The information processing apparatus according to claim 12, wherein the detection information includes at least one of sound information, performance time, a performance tempo, a sound production interval, a movement of the performer, a center of gravity of the performer, or a condition of a body of the performer.

14. The information processing apparatus according to claim 12, wherein the supplemental information includes at least one of correct performance information, past performance information, or information regarding another performance sound.

15. The information processing apparatus according to claim 1, further comprising an outputter configured to output assist information for improving the proficiency.

16. The information processing apparatus according to claim 15, wherein the assist information includes at least one of a virtual image, a comment on the proficiency, or a history of the proficiency.

17. The information processing apparatus according to claim 16, wherein the virtual image is superimposed on a real object.

18. The information processing apparatus according to claim 17, wherein the virtual image shows at least one of a movement of a stick used to play the drum or a movement of the performer.

19. A computer system-implemented method for processing information, the method comprising:
obtaining an image of a performer playing a drum; and
evaluating a proficiency of the performer in playing the drum based on the obtained image.

20. A non-transitory computer-readable storage medium storing a program which, when executed by a computer system, causes the computer system to:
obtain an image of a performer playing a drum; and
evaluate a proficiency of the performer in playing the drum based on the obtained image.
